(19) United States
(12) Patent Application Publication
(10) Pub. No.: US 2004/0224573 A1
(43) Pub. Date: Nov. 11, 2004

(54) Female terminal

(75) Inventors: Haruki Yoshida, Shizuoka (JP); Yositaka Ito, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/779,880

(22) Filed: Feb. 18, 2004

(30) Foreign Application Priority Data
Feb. 18, 2003 (JP) P2003-039687

(51) Int. Cl. H01R 13/40

(52) U.S. Cl. 439/852

(57) ABSTRACT

A female terminal includes a resilient contact piece portion extending rearwardly from a front end edge of a bottom wall of a mating terminal-inserting portion of a tubular shape, and a free end portion of the resilient contact piece portion can slide over the bottom wall. A convex portion is formed at the free end portion of the resilient contact piece portion, and projects toward the bottom wall, and when the resilient contact piece portion is resiliently deformed upon insertion of a male terminal, the convex portion is brought into contact with the bottom wall, so that that portion of the resilient contact piece portion, extending forwardly from that portion of the convex portion contacted with the bottom wall, is spaced from the bottom wall by the convex portion.

The present application is based on Japanese Patent Application No. 2003-39687, the entire contents of which are incorporated herein by reference.

### BACKGROUND OF THE INVENTION

1. Field of the Invention

This invention relates to an improved female terminal in which a resilient contact piece portion extends rearwardly from a front end edge of a bottom wall of a mating terminal-inserting portion of a tubular shape, and a free end portion of the resilient contact piece portion can slide over the bottom wall.

2. Related Art

There is known a conventional female terminal in which a mating terminal-inserting portion of a rectangular tubular shape is provided at a front end of a wire connection portion, and a resilient contact piece portion is provided within the mating terminal-inserting portion, and a male terminal, when inserted into the mating terminal-inserting portion, is held between the resilient contact piece portion and a top wall of the mating terminal-inserting portion (see, for example, JP-A-9-289055, FIG. 2).

FIGS. 3 and 4 are a cross-sectional view of the conventional female terminal and an enlarged view of an important portion thereof, respectively, showing the construction thereof.

As shown in FIGS. 3 and 4, the female terminal 1 includes the mating terminal-insertion portion 2 provided at the front end of the wire connection portion 3 to which an end portion of a wire (not shown) is adapted to be connected, and the male terminal 20 can be inserted into the mating terminal-inserting portion 2 to be electrically connected to the female terminal.

The resilient contact piece portion 6, extending rearwardly from the front end edge of the bottom wall 4, is provided within the mating terminal-inserting portion 2 of a tubular shape, and the free end portion 6a of this resilient contact piece portion can slide over the bottom wall 4.

The resilient contact piece portion 6 is formed integrally at the front end edge of the bottom wall 4, and an intermediate portion 6b thereof is curved into an arch-shape to project toward the top wall 6, and the free end portion 6a can slide over an upper surface of the bottom wall 4, and a distal end of this free end portion 6a is turned upwardly so as not to become caught by the bottom wall during the sliding movement.

When the male terminal 20 is inserted into the mating terminal-inserting portion 2 of the female terminal 1 as shown in FIG. 4, the male terminal 20 enters the mating terminal-inserting portion 2 while depressing the intermediate portion 6b of the resilient contact piece portion 6, and is held between the resiliently-deformed resilient contact piece portion 6 and the top wall 5.

In this condition, the female terminal 1 and the male terminal 20 are electrically connected together. During the insertion of the male terminal 20, the resilient contact piece portion 6 is resiliently deformed while it is supported at its opposite ends (that is, at a folded-back portion 6c (formed integrally on the front end edge of the bottom wall 4) and the free end portion 6a held in contact with the bottom wall 4), and a spring reaction force, resulting from this deformation, is imparted as a holding or gripping force to the male terminal 20. Therefore, this spring reaction force serves as a resistance to the insertion of the male terminal 20.

In the above conventional female terminal 1, the resilient contact piece portion 6 is resiliently deformed upon insertion of the male terminal 20 into this female terminal as shown in FIG. 4, and as the amount of this resilient deformation increases, the free end portion 6a of the resilient contact piece portion 6 is generally flattened, and gradually comes into surface-to-surface contact with the bottom wall 4, so that a support point P at the distal end portion 6a shifts to a forward position PA.

As a result, the distance L between the two end support points decreases, so that the spring constant increases, and this has invited a problem that the inserting force (inserting resistance) of the male terminal 20 increases. And besides, the amount of shifting of the support point P of the resilient contact piece portion 6 varies, depending on the thickness of the male terminal 20, and therefore a load of contact between the male terminal 20 and the resilient contact piece portion 6 is liable to be varied by an error falling within the range of a tolerance of the male terminal 20. As a result, there has been encountered a problem that the quality control is difficult.

### SUMMARY OF THE INVENTION

It is therefore an object of this invention to solve the above problems, and more specifically to provide a good female terminal which decreases an inserting force of a male terminal, and enables a contact load to be easily controlled.

The above object of the present invention has been achieved by a female terminal as defined in claim 1 wherein the female terminal includes a resilient contact piece portion extending rearwardly from a front end edge of a bottom wall of a mating terminal-inserting portion of a tubular shape, and a free end portion of the resilient contact piece portion can slide over the bottom wall; characterized in that:

a convex portion is formed at the free end portion of the resilient contact piece portion, and projects toward the bottom wall, and when the resilient contact piece portion is resiliently deformed upon insertion of a male terminal, the convex portion is brought into contact with the bottom wall, so that that portion of the resilient contact piece portion, extending forwardly from that portion of the convex portion contacted with the bottom wall, is spaced from the bottom wall by the convex portion.

In the female terminal of the above construction, the convex portion, projecting toward the bottom wall, is formed at the free end portion of the resilient contact piece portion, and the convex portion is adapted to contact the bottom wall, and therefore a clearance can always be secured between the resilient contact piece portion and the bottom wall over the region extending forwardly from that portion of the convex portion contacted with the bottom wall.

Therefore, during the time when the resilient contact piece portion is resiliently deformed in accordance with the insertion of the male terminal, a support point at the free end portion of the resilient contact piece portion will not gradually shift forwardly relative to the bottom wall, and therefore the distance between the two support points, disposed respectively at the opposite end portions of the resilient contact piece portion (that is, a substantial spring length), is kept constant, so that a spring constant is kept constant.

Accordingly, an inserting resistance will not increase as the insertion of the male terminal proceeds, and the male terminal can always be inserted with a constant force. And besides, the distance between the two end support points of the resilient contact piece portion will not change, so that the spring constant of the resilient contact piece portion can be kept constant. Therefore, a variation in contact load of the resilient contact piece portion due to an error within the range of a tolerance of the male terminal can be made small, so that the quality control is easy, and this contributes to the improved productivity.

### BRIEF DESCRIPTION OF THE DRAWINGS

FIG. 1 is a longitudinal cross-sectional view of one preferred embodiment of a female terminal of the present invention;

FIG. 2 is an enlarged cross-sectional view of an important portion, showing a condition in which a male terminal is inserted in the female terminal of FIG. 1;

FIG. 3 is a longitudinal cross-sectional view of a conventional female terminal; and

FIG. 4 is an enlarged cross-sectional view of an important portion, showing a condition in which a male terminal is inserted in the female terminal of FIG. 3.

### DETAILED DESCRIPTION OF THE PREFERRED EMBODIMENT

One preferred embodiment of a female terminal of the present invention will now be described in detail with reference to the accompanying drawings.

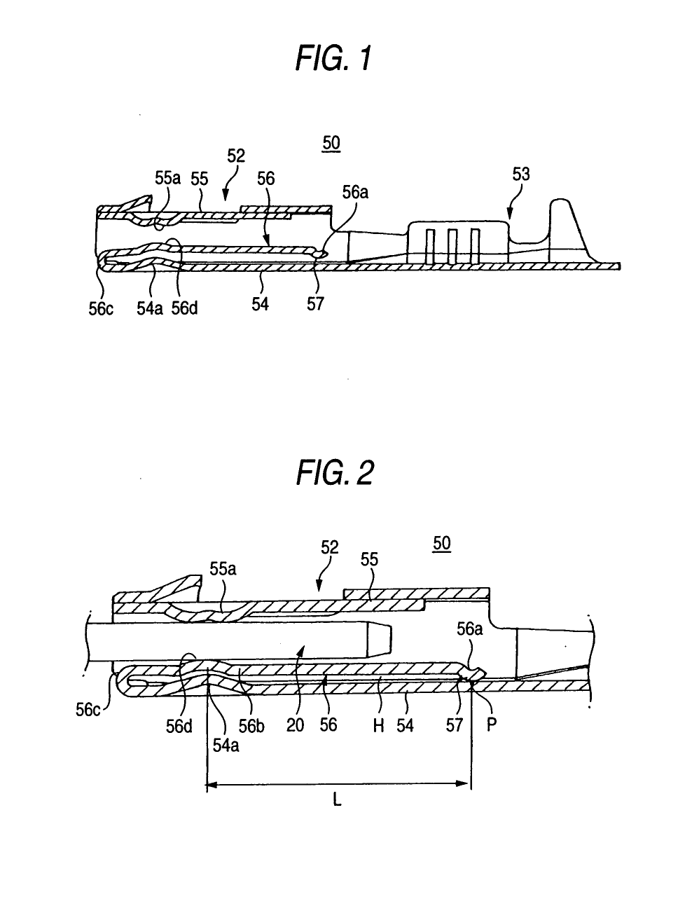

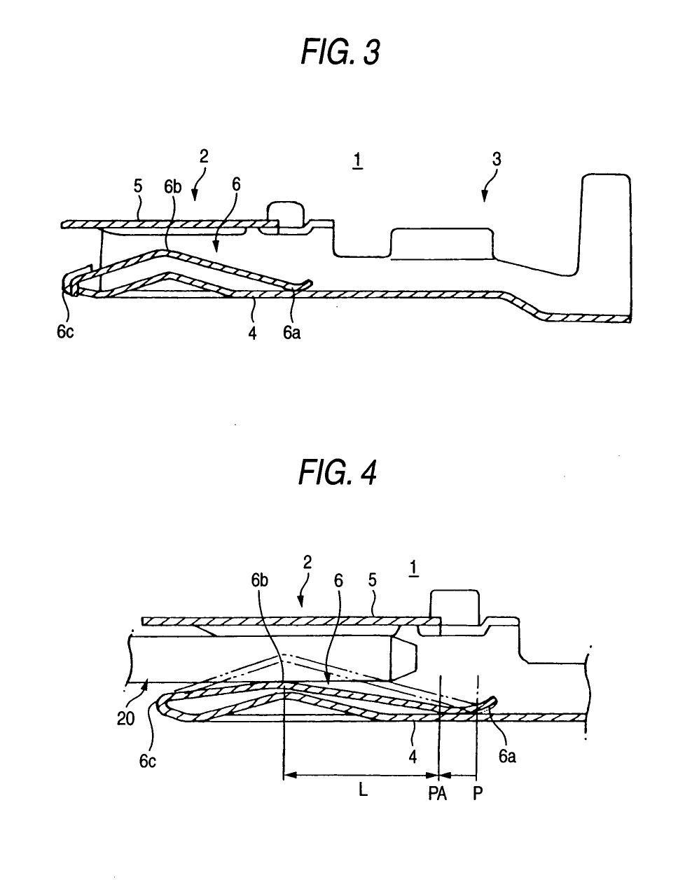

FIG. 1 is a longitudinal cross-sectional view of one preferred embodiment of the female terminal of the invention, and FIG. 2 is an enlarged cross-sectional view of an important portion, showing a condition in which a male terminal is inserted in the female terminal of FIG. 1.

As shown in FIGS. 1 and 2, the female terminal 50 of this embodiment includes a mating terminal-inserting portion 52 provided at a front end of a wire connection portion 53 to which an end portion of a wire (not shown) is adapted to be connected. A male terminal 20 can be inserted into the mating terminal-inserting portion 52 to be electrically connected to the female terminal.

A resilient contact piece portion 56, extending rearwardly from a front end edge of a bottom wall 54, is provided within the mating terminal-inserting portion 52 of a rectangular tubular shape, and a free end portion 56a of this resilient contact piece portion can slide over the bottom wall 54.

The resilient contact piece portion 56 is formed integrally at the front end edge of the bottom wall 54 through a folded-back portion 56c, and its intermediate portion 56b has a curved portion 56d which is curved into an arch-shape to project toward a curved portion 55a formed at a top wall 55. The intermediate portion 56b are provided almost parallel to the bottom wall 54 at a predetermined clearance. Thus, the resilient contact piece portion 56 is configured almost parallel to an insertion direction of the male terminal 20 over the section from the folded-back portion 56c to the free end portion 56a except the curved portion 56b. Accordingly, when the male terminal 20 is inserted into the terminal-inserting portion 52, only the curved portion 56b is brought into contact with the male terminal among the entire resilient contact piece portion 56b. Further, a curved portion 55a is formed on the top wall 55 so as to oppose to the curved portion 56d. The male terminal 20 is clamped by the opposing curved portions 55a, 56d. Insertion resistance due to the curved portions 55a, 56d is almost constant during the insertion of the male terminal 20 since clamping condition between the male terminal 20 and the curved portions 55a, 56d does not vary.

A curved portion 54a is formed on the bottom wall 54 at a position corresponding to the curved portion 56d of the resilient contact piece portion 56. The curved portion 54a provides an effect to restrict deformation of the resilient contact piece portion 56. That is, when the terminal 20 is inserted, even in a case that the resilient contact piece portion 56 is excessively bent or deformed, the curved portion 54a of the bottom wall 54 supports the curved portion 56d of the resilient contact piece portion 56 from the lower side, thereby restricting the bending of the resilient contact piece so as not to be excessively deformed.

Meanwhile, a convex portion 57, projecting toward the bottom wall 54, is formed at the free end portion 56a of the resilient contact piece portion 56. The convex portion 57 is bent into a semi-arc-shaped cross-section to project toward the bottom wall 54. When the resilient contact piece portion 56 is resiliently deformed upon insertion of the male terminal 20 into the terminal-inserting portion 52, the convex portion 57 is brought into contact with the bottom wall 54, so that a front side part of the resilient contact piece portion 56 is spaced from the bottom wall 54 with a clearance.

Namely, in the female terminal 50 of this embodiment, the convex portion 57, projecting toward the bottom wall 54, is formed at the free end portion 56a of the resilient contact piece portion 56, and the convex portion 57 is adapted to contact the bottom wall 54 as shown in FIG. 2, and therefore a clearance H can always be secured between the resilient contact piece portion 56 and the bottom wall 54 over the region extending forwardly from that portion of the convex portion 57 contacted with the bottom wall 54.

Incidentally, the cross-section of the convex portion 57 is shaped in the semi-arc-shape because the contact area of the convex portion 57 to the bottom wall 54 does not vary very much even if an amplitude of deformation, namely bending of the resilient contact piece portion 56 is changed upon the insertion of the male terminal 20. Accordingly, the sliding property of the resilient contact piece portion 56 on the bottom wall 54 and the substantial spring length are hardly affected.

Therefore, during the time when the resilient contact piece portion 56 is resiliently deformed in accordance with the insertion of the male terminal 20, a support point P at the free end portion of the resilient contact piece portion 56 will not gradually shift forwardly relative to the bottom wall 54, and therefore the distance L between the two support points 56a and 56d, disposed respectively at the opposite end portions of the resilient contact piece portion 56 (that is, a substantial spring length), is kept constant, so that a spring constant is kept constant.

Therefore, an inserting resistance will not increase as the insertion of the male terminal 20 proceeds, and the male terminal 20 can always be inserted with a constant force. And besides, the distance L between the two end support points 56a and 56d of the resilient contact piece portion 56 will not change, so that the spring constant of the resilient contact piece portion 56 can be kept constant. Therefore, a variation in contact load of the resilient contact piece portion 56 due to an error within the range of a tolerance of the male terminal 20 can be made small, so that the quality control is easy, and this contributes to the improved productivity.

The resilient contact piece portion 56 and convex portion 57 of the female terminal of the invention are not limited to their respective constructions illustrated in the above embodiment, and each of them can take any other suitable form.

For example, the convex portion can be defined by a convex portion which is formed into a semi-spherical shape at the time of pressing the female terminal.

As described above, in the female terminal of the present invention, the convex portion, projecting toward the bottom wall, is formed at the free end portion of the resilient contact piece portion, and the convex portion is adapted to contact the bottom wall, and therefore the clearance can always be secured between the resilient contact piece portion and the bottom wall over the region extending forwardly from that portion of the convex portion contacted with the bottom wall.

Therefore, during the time when the resilient contact piece portion is resiliently deformed in accordance with the insertion of the male terminal, the support point at the free end portion of the resilient contact piece portion will not gradually shift forwardly relative to the bottom wall, and therefore the distance between the two support points, disposed respectively at the opposite end portions of the resilient contact piece portion (that is, the substantial spring length), is kept constant, so that the spring constant is kept constant.

Therefore, the inserting resistance will not increase as the insertion of the male terminal proceeds, and the male terminal can always be inserted with the constant force. And besides, the distance between the two end support points of the resilient contact piece portion will not change, so that the spring constant of the resilient contact piece portion can be kept constant. Therefore, a variation in contact load of the resilient contact piece portion due to an error within the range of the tolerance of the male terminal can be made small, so that the quality control is easy, and this contributes to the improved productivity.

What is claimed is:

1. A female terminal comprising:
a terminal-inserting portion having a bottom wall and a resilient contact piece portion extending rearwardly from a front end edge of the bottom wall to a free end portion thereof;
wherein a convex portion projecting toward said bottom wall is formed at the free end portion of said resilient contact piece portion, and
when said resilient contact piece portion is resiliently deformed upon insertion of a male terminal, said convex portion is brought into contact with said bottom wall, so that a front side part of said resilient contact piece portion is spaced from said bottom wall with a clearance.

2. A female terminal according to claim 1, wherein said resilient contact piece portion includes a first curved portion by which said male terminal is clamped.

3. A female terminal according to claim 2, wherein said resilient contact piece portion extends almost parallel to an insertion direction of said male terminal except said first curved portion.

4. A female terminal according to claim 2, wherein a second curved portion by which said male terminal is clamed is formed on a top wall of said terminal-inserting portion.

5. A female terminal according to claim 4, wherein said first curved portion and said second curved portion are opposed to each other.

6. A female terminal according to claim 2, wherein said resilient contact piece portion extends almost parallel to said bottom wall except said first curved portion so as to form a clearance there between.

7. A female terminal according to claim 1, wherein a third curved portion is formed on said bottom wall at a position corresponding to said first curved portion.

8. A female terminal according to claim 1, wherein said convex portion has a semi-arc shape in cross-section.
